(19) United States
(12) Patent Application Publication
(10) Pub. No.: US 2005/0182801 A1
(43) Pub. Date: Aug. 18, 2005

(54) Synchronization reconciling in data storage library systems

(75) Inventors: Thomas William Bish, Tucson, AZ (US); Brian Dean Rasmussen, Tucson, AZ (US)

Correspondence Address: John H. Holcombe;IBM Corporation, Intellectual Property Law, 8987 E. Tanque Verde Rd. #309-374, Tucson, AZ, 85749-9610, US

(73) Assignee: INTERNATIONAL BUSINESS MACHINES CORPORATION, Armonk, NY (US)

(21) Appl. No.: 10/779,218

(22) Filed: Feb. 13, 2004

(51) Int. Cl. G06F 12/00

(52) U.S. Cl. 707/203

(57) ABSTRACT

Bulk synchronization reconciling maintains data volumes at the same version in redundant data storage libraries. Tokens of each library describe version-related characteristic(s) of an associated volume of data. At least one director establishes a reconcile set of tokens of the libraries describing dissimilar version-related characteristics of a same associated volume. A plurality of subsets of the reconcile set of tokens are established based on a first criteria, and allotted to directors to reconcile the data of volumes of the subsets, to split the reconciling between the directors. An example is to select subsets based on the last binary digit of the volume identifier, e.g. odd and even numbered subsets. Alternatively, the volume identifiers may be split into upper and lower halves. Further, the directors reconcile in a sequence based on a second criteria, e.g., one in numerical sequence, and another in reverse numerical sequence.

### FIELD OF THE INVENTION

This invention relates to data storage library systems, and, more particularly, to reconciling of data in redundant data storage libraries to maintain synchronization of the data for the same volumes between the redundant data storage libraries.

### BACKGROUND OF THE INVENTION

Data storage libraries maintain sets of volumes, each of which can contain data, as backup for information handling systems. Reliability is enhanced by having redundant data storage libraries, each separately maintaining the same volumes.

An example of redundant storage libraries is a peer-to-peer arrangement of International Business Machines Corp. Magstar Virtual Tape Servers. The arrangement is a largely self-managed set of data storage libraries and directors which can provide access and storage for the same data volumes in both libraries (i.e. Peer-to-peer, or P2P). If an operation to recall a data volume from one virtual tape server library fails, then the volume may still be recalled from the other virtual tape server library. Therefore, when a host system writes or updates data that is to be stored, the data will be saved at both virtual tape servers. The data may be supplied at one time to both virtual tape servers, or, in a peer-to-peer arrangement, the data is written to one virtual tape server and subsequently copied from the one virtual tape server (data storage library) to the other virtual tape server (data storage library). Until it is copied, the data of the volume is likely to be different in the one data storage library as compared to the volume of the other data storage library.

Data is transferred to the redundant data storage libraries by at least one director. Reliability is further enhanced by employing a plurality of directors. A function of the directors is to insure that the data of the volumes is synchronized between the redundant data storage libraries, typically comprising two data storage libraries, although additional redundant libraries may be employed. Synchronization of the volumes may be maintained using tokens, which describe at least one version-related characteristic of the volumes.

Tokens allow a comparison of the tokens to be made to determine whether the data of the volumes are synchronized, and if not, which data is more recent. The tokens may have different version-related characteristics, such as different time stamps, and a token representing one copy may have a flag that indicates whether a copy is required, or that the data is inconsistent. Based on an examination of tokens, a director copies the most recent data of a volume from one data storage library to another data storage library, to synchronize the data. An example of a director is an IBM Virtual Tape Controller (VTC) which transparently transfers data and executes commands from one or more host systems with respect to data storage libraries. A plurality of directors may be employed in a Virtual Tape Server P2P system, such as 4 or 8 directors.

The synchronization process can take place immediately or be deferred. For example, a Wall Street firm may desire a high peak host input/output during trading hours, and choose to defer the copying function until after hours. If deferred, the number of volumes to be copied may become large. In addition, should one of the data storage libraries fail or be offline, the director will operate in deferred mode. The process for synchronizing the data of redundant data storage libraries from an extended deferred mode where there are a large number of volumes is called bulk reconciliation. To do a bulk reconcile, a director requests all of the tokens from each data storage library, compares the tokens of all the volumes, and reconciles the volumes that need it. This can be a lengthy process, taking up to about 2 seconds per volume. A data storage library can support a vast number of volumes (although typically only a fraction of the volumes would need reconciliation) so that the bulk reconcile could take hours to complete.

### SUMMARY OF THE INVENTION

The present invention comprises a data storage system, a director, a computer program product, and a method for synchronization reconciling data to be maintained in redundant data storage libraries, each data storage library having tokens, each token describing at least one version-related characteristic of an associated volume of data stored by the data storage library. The directors are capable of communicating with the redundant data storage libraries.

At least one of the directors establishes a reconcile set of the tokens, comprising tokens of the redundant data storage libraries describing dissimilar version-related characteristics of a same associated volume. A plurality of subsets of the reconcile set of tokens are established based on a first predetermined criteria; and allotted to directors to reconcile the data of volumes of the subsets of the reconcile set of tokens. Thus, the reconcile is split between the plurality of directors.

In one embodiment, the first predetermined criteria is based on the volume identifier of the associated volume. An example is to select subsets based on the last binary digit of the volume identifier, i.e. odd and even numbered subsets. Alternatively, the volume identifiers may be selected to be split into upper and lower halves.

Additionally, in another embodiment, the directors reconciling the data of volumes, conduct the reconcile of the data of the volumes associated with the allotted subset of tokens, in a sequence based on a second predetermined criteria. In one embodiment, the second predetermined criteria is based on the volume identifier of the associated volume, for example, if multiple directors are allotted odd numbered subsets to reconcile, one or more conducts the reconcile in numerical sequence, and another or others conduct the reconcile in reverse numerical sequence, as the second predetermined criteria.

In a further embodiment, a director, when reconciling the data of volumes of a subset of the reconcile set of tokens, additionally senses that tokens for a volume are being re-read and the data of the volume associated with the re-read tokens has been reconciled, and, ceases reconciling the data of the volumes associated with the tokens of the subset.

Still further, the director, in response to ceasing reconciling the data of the volumes associated with the tokens of the subset, reconciles the data of volumes of the reconcile set of tokens.

For a fuller understanding of the present invention, reference should be made to the following detailed description taken in conjunction with the accompanying drawings.

### BRIEF DESCRIPTION OF THE DRAWINGS

FIG. 1 is a block diagram of an embodiment of a data storage system in accordance with the present invention and a plurality of host systems;

FIG. 2 is a block diagram of an example of a data storage library of the data storage system of FIG. 1;

FIG. 3 is a diagrammatic representation of a token employed in the data storage system of FIG. 1;

FIG. 4 is a flow chart depicting an embodiment of the present invention for synchronization reconciling data to be maintained in the data storage libraries of FIG. 1; and

FIG. 5 is a diagrammatic representation of subsets of a reconcile set of tokens in accordance with the present invention.

### DETAILED DESCRIPTION OF THE INVENTION

This invention is described in preferred embodiments in the following description with reference to the Figures, in which like numbers represent the same or similar elements. While this invention is described in terms of the best mode for achieving this invention's objectives, it will be appreciated by those skilled in the art that variations may be accomplished in view of these teachings without deviating from the spirit or scope of the invention.

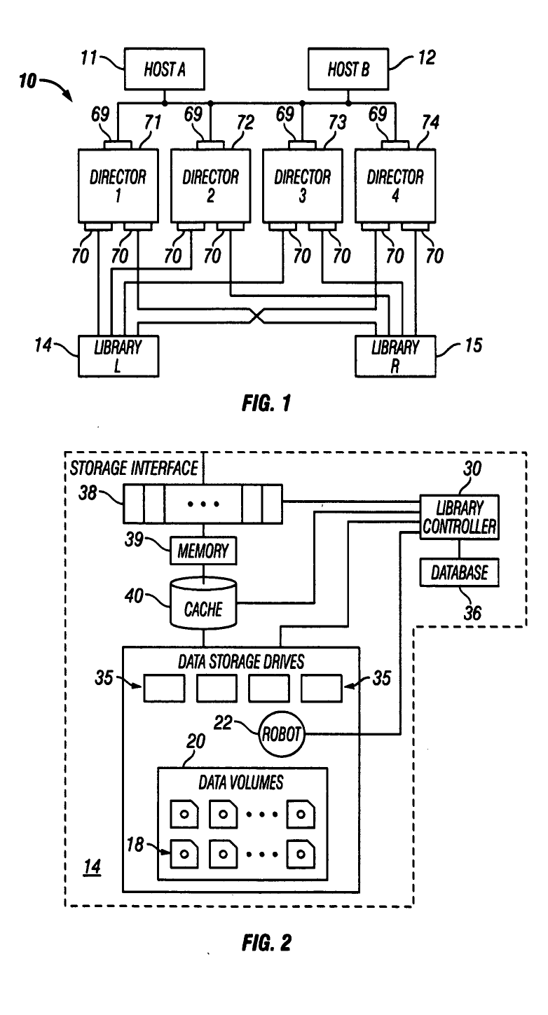

Referring to FIG. 1, an embodiment of a data storage system 10 is illustrated which couples host systems 11 and 12 to redundant data storage libraries 14 and 15. The host systems 11 and 12 may comprise a variety of types and numbers of processing units, servers, or computing systems. The data storage libraries 14 and 15 may comprise any similar libraries for storing data, such as removable rewritable data storage media, e.g. tape cartridges or optical disks, such that the libraries are redundant, comprising at least two libraries. An example of redundant storage libraries is a peer-to-peer arrangement of International Business Machines Corp. Magstar Virtual Tape Servers (P2P VTS).

Referring additionally to FIG. 2, data storage libraries 14 and 15 provide storage and access to large quantities of logical data volumes stored in removable data storage media 18. As an example, hundreds of logical data volumes (herein “volumes”) may comprise a single removable data storage media. The data storage media 18 are stored in storage shelves 20 which are accessed by at least one robot 22 under the control of a library controller 30. A plurality of data storage drives 35 are provided in the library to allow access to read and/or write data to the data storage media 18. The library controller 30 may comprise a library manager which utilizes a database 36 to track each volume and the data storage media 18 on which it is stored, and to track the storage shelf location 20 of each data storage media. Communication with the library is conducted at a storage interface 38 to a buffer memory 39, and to the addressed drive 35.

A virtual tape server data storage library has a nonvolatile cache memory 40, which stores active data and comprises virtual data storage drives. When a volume is initially accessed, the library controller 30 identifies the data storage media 18 having the volume, or if the volume is to be written, selects a data storage media for the logical data volume. The library controller then operates the robot 22 to access the data storage media from the storage shelf and delivers the data storage media to a data storage drive 35. The volume is maintained in cache memory 40 for access by the host system, and for immediate future access, if needed. If not needed, eventually, the volume is deleted from cache memory. If the volume is written or updated, the data storage media 18 for the volume is again accessed and the written or updated volume is written to the data storage media.

The volumes are typically accessed using an identifier of the volume, which may comprise a binary identifier, called volume identifier or “VOLID”.

In FIG. 1, a plurality of directors 71-74 are illustrated, each comprising a programmable computer processor, called a director controller, having computer readable code for operating the director controller. Each director 71-74 additionally comprises interfaces 69 appropriate to communication links to the host systems 11 and 12, and comprises interfaces 70 appropriate to communication links to the redundant data storage libraries 14 and 15. Examples of communication links comprise ESCON, FICON or SCSI, as are known to those of skill in the art. Thus, each director 71-74 is in communication with the host systems 11 and 12 and with all of the redundant data storage libraries 14 and 15.

Redundant data storage libraries may comprise libraries in different locations for the purpose of disaster recovery. In the example of FIG. 1, library 14 is local, and library 15 is remote, and the communication links are appropriate to the communication distance. Each director is provided with an operating system and application programs for operating in accordance with the present invention. The application programs may comprise a computer program product, and may be supplied electronically, as from a network or one of the host systems. Alternatively, the computer program product may comprise a tangible media, such as a CDROM, and may be supplied at an I/O station of the computer processor or from a data storage drive at a data storage library.

The directors 71-74 are typically partitioned to conduct typical storage work for the redundant libraries. For example, volume identifiers (VOLID) are partitioned between the directors. In another example, the data storage drive addresses are partitioned between the directors. Thus, the director having the partitioned address responds to a host command regarding the partitioned VOLID or drive address.

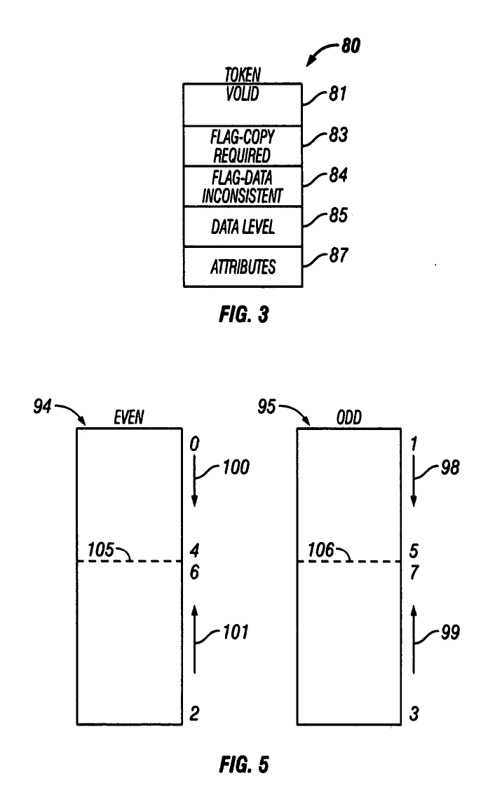

Referring to FIG. 3, each library provides a token 80 associated with each volume. A token is a structure that describes characteristics of a volume of a data storage library. A purpose of the tokens are to be able to synchronize the data of the same volume at each of the redundant data storage libraries. Thus, each token 80 describes at least one version-related characteristic of an associated volume of data stored by the data storage library.

The VOLID 81 is the volume identifier of the volume of data that the token describes.

The flag 83 represents that copying is required. As discussed above, when a volume changes, it changes on one data storage library first and then is copied to the other data storage library. This flag indicates that the volume has changed and now needs to be copied to the other data storage library(ies).

The flag 84 represents that the data of the associated volume is inconsistent, meaning that the data is not the latest copy of the volume, and that the data on the other data storage library should be more up to date (and probably has the copy required flag set).

The flags 83 and 84 may comprise a property attribute section of the token.

The data level indication 85 is a timestamp that is incremented each time that the associated volume changes. This helps to keep track of which data storage library has the valid volume data.

Section 87 indicates other attributes of a volume. The attributes of volumes in a data storage library can be employed as an added level of data management. These attribute fields in the token may be used similarly to the data inconsistent and data level fields to assist in keeping the attribute information in synchronization.

Referring to FIGS. 1, 3, 4 and 5, a batch reconcile 90 is conducted to update a large number of volumes. For example, the synchronization process can be deferred, or one of the data storage libraries can fail or be offline and the director will operate in deferred mode, and, as the result, a large number of volumes will require synchronization updating. The process for synchronizing the data of redundant data storage libraries from an extended deferred mode where there is a large amount of data is called bulk reconciliation. To do a bulk reconcile, at least one of the directors 71-74 requests a listing with all of the tokens 80 from each data storage library (called a bulk token read), and compares the levels and flags of the tokens discussed above. The director can easily determine which volumes need to be reconciled. A volume needs to be reconciled if the data is inconsistent, needs to be copied, or if the timestamps or attributes are out of sync.

From a comparison of the tokens of all the volumes, the directors establish 91 a reconcile set of tokens, comprising tokens of the redundant data storage libraries having dissimilar version-related characteristics of a same associated volume. The bulk token read allows the directors to filter out and create a list of all volumes that need to be reconciled.

Alternatively, the tokens can be read individually and compared, but a bulk token read is fast as compared to reading all tokens individually.

In step 93, the director(s) establish a plurality of subsets of the reconcile set of tokens based on a first predetermined criteria. In one embodiment, the first predetermined criteria is based on the volume identifier (VOLID 81) of the associated volume. An example is to select subsets based on the last binary digit of the volume identifier, i.e. odd and even numbered subsets. Alternatively, the volume identifiers may be selected to be split into upper and lower halves. This splits the reconcile set of volumes to be reconciled into two different subsets 94 and 95. Additionally, further subsets may also be established. For example, the volume identifiers may be split into quartiles, or the odd and even sets may also be split into upper and lower halves.

In step 96, the subsets 94, 95 are allotted to different directors 71-74 to reconcile the data of volumes of the subsets of the reconcile set of tokens. Thus, the reconcile is split between the plurality of directors 71-74. The number of directors must be at least two for the split, and may comprise any number in excess of one. The allotting of the subsets of tokens may be accomplished in any of several ways. One director may establish the subsets of tokens, for example, as ranges of volumes, and communicates separate subsets to other directors. One director may establish the subsets of tokens and communicates all the subsets to the other directors, and each director selects its predetermined reconcile subset. The full reconcile set may be provided to all of the directors, and each director selects its predetermined reconcile subset. Alternatively, various combinations may be employed, such as dividing the directors into groups, each group having a “master” director allot or communicate subsets to the other directors a group. Further, it is not necessary that all of the directors of a system conduct the reconcile. A “plurality of directors” may comprise one grouping out of all of the directors.

The established set and subsets of tokens may comprise, for example, a listing of volumes, ordered, for example, alphabetically or, in binary form, numerically.

In one embodiment, the directors conduct the reconcile of the allotted subsets of tokens.

Additionally, in another embodiment, multiple directors 71-74 are allotted the same subset of volumes to reconcile. For example, directors 71 and 72 are allotted the even numbered VOLID subset 94, and directors 73 and 74 are allotted the odd numbered VOLID subset 95, to reconcile between data storage libraries 14 and 15.

In this embodiment, the directors 71-74 reconciling the data of the volumes, in step 97, conduct the reconcile of the data of the volumes associated with the allotted tokens, in a sequence based on a second predetermined criteria. The allotting of the subsets of tokens may be accomplished in any of several ways. Each of the directors may be programmed with its second predetermined criteria, or pattern; may be programmed with all of the criteria, and select the criteria to employ; may be provided with the criteria with the allotment of a subset; etc. In one embodiment, the second predetermined criteria is based on the volume identifier of the associated volume. For example, if multiple directors are allotted odd numbered subsets 95, to reconcile one or more of the directors conducts the reconcile in numerical sequence, shown by arrow 98, and another or others conduct the reconcile in reverse numerical sequence, shown by arrow 99, as the second predetermined criteria. In another example, if multiple directors are allotted the reconcile of even numbered subsets 94, one or more of the directors conducts the reconcile in numerical sequence, shown by arrow 100, and another or others conduct the reconcile in reverse numerical sequence, shown by arrow 101, as the second predetermined criteria. Thus, the reconcile is further split among the directors 71-74.

The directors that are conducting the reconcile continue reconciling the data of the allotted subset 94 or 95, and will, at some point, reach the halfway point 105, 106. In one embodiment, the director completes the bulk reconcile at that point.

In a further embodiment, a director 71-74, when reconciling the data of volumes of a subset 94, 95 of the reconcile set of tokens, may continue beyond the halfway point 105, 106. In doing so, at some point, in step 107, the director will read a token that has already been read by another director which has reconciled the data of the associated volume. When a volume is reconciled by one director, the token is updated on each data storage library to clear token fields 83, 84, 85, 87 that would indicate a reconcile is required. However, the other directors are not necessarily notified when volume tokens have changed and the volume has been reconciled. Therefore, a director should, in step 107, do an individual read of the volume tokens before attempting to reconcile it to be sure to avoid wasting time doing work that another director has already completed. By doing the re-read of a token 80, the director additionally senses that tokens for a volume are being re-read and the data of the volume associated with the re-read tokens has been reconciled, and, the director 71-74 ceases reconciling the data of the volumes associated with the tokens of the subset 94, 95.

Re-reading the tokens takes only a fraction of the time needed to fully reconcile a volume, so once the directors start to overlap in the volumes they reconcile, the process finishes quickly.

Still further, in another embodiment, the director 71-74, in step 108, in response to ceasing reconciling the data of the volumes associated with the tokens of the subset 94, 95, verifies the reconcile of the data of volumes of the full reconcile set of tokens. For example, if directors reconciling allotted subset 94 complete the reconcile before the directors reconciling allotted subset 95 complete their reconcile, one or more of the directors completing the reconcile may then verify the reconcile of the full set and reconcile the data of any unreconciled volume. For example, each director may be provided with the full reconcile set in the form of an alphabetical listing of volumes. As the director reconciles the data of a volume, the volume is removed from the list. Thus, after the reconcile of the subset is completed, the director has a list that is still sorted alphabetically and contains only the volumes that this director has not reconciled. At this point, in step 108, the director starts at the top of the list, confirming that each volume has been reconciled, and reconciling the volume if it has not been reconciled. The order of the second pass may be alphabetical.

The result is a speed-up of the bulk token reconcile process.

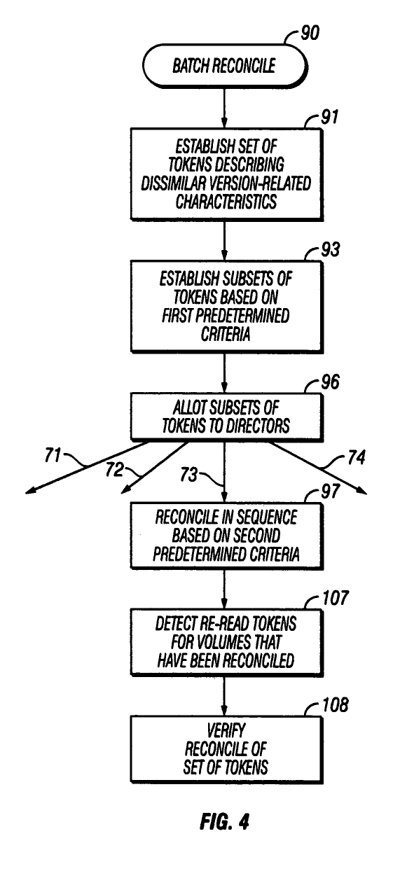

The illustrated components of the data storage system(s), directors, and data storage libraries of FIGS. 1 and 2, and the arrangement of the tokens and subsets of FIGS. 3 and 5 may be varied, combined, or combined functions may be separated, as is known to those of skill in the art. The illustrated steps of FIG. 4 may be altered in sequence, omitted, or other steps added, as is known to those of skill in the art.

While the preferred embodiments of the present invention have been illustrated in detail, it should be apparent that modifications and adaptations to those embodiments may occur to one skilled in the art without departing from the scope of the present invention as set forth in the following claims.

1. A data storage system for synchronization reconciling data to be maintained in redundant data storage libraries, each said data storage library having tokens, each said token describing at least one version-related characteristic of an associated volume of data stored by said data storage library, comprising:
a plurality of directors, each capable of communicating with said redundant data storage libraries;
at least one of said plurality of directors establishing a reconcile set of said tokens comprising tokens of said redundant data storage libraries describing dissimilar version-related characteristics of a same associated volume;
at least one of said plurality of directors establishing a plurality of subsets of said reconcile set of tokens based on a first predetermined criteria; and
said plurality of directors reconciling the data of volumes of allotted said subsets of said reconcile set of tokens, thereby splitting the reconcile between said directors.

2. The data storage system of claim 1, wherein said first predetermined criteria is based on the volume identifier of said associated volume.

3. The data storage system of claim 1, wherein at least one of said plurality of directors reconciling the data of volumes of a said allotted subset of said reconcile set of tokens, reconciles the data of said volumes associated with said tokens in a sequence based on a second predetermined criteria.

4. The data storage system of claim 3, wherein said second predetermined criteria is based on the volume identifier of said associated volume.

5. The data storage system of claim 3, wherein at least one of said plurality of directors reconciling the data of volumes of a said allotted subset of said reconcile set of tokens, additionally senses that a token is being re-read and the data of said volume associated with said re-read token has been reconciled, and ceases reconciling said data of said volumes associated with said tokens of said subset.

6. The data storage system of claim 5, wherein said at least one of said plurality of directors ceasing reconciling said data of said volumes associated with said tokens of said subset, reconciles the data of volumes of said reconcile set of tokens.

7. A director for synchronization reconciling data to be maintained in redundant data storage libraries, each said data storage library having tokens, each said token describing at least one version-related characteristic of an associated volume of data stored by said data storage library, comprising:
a communication interface for communication, via a communication link, with each of said redundant data storage libraries; and
a director control, said director control:
establishing a reconcile set of said tokens comprising tokens of said redundant data storage libraries describing dissimliar version-related characteristics of a same associated volume;
establishing at least one of a plurality of subsets of said reconcile set of tokens based on a first predetermined criteria; and
reconciling the data of volumes of an alloted said subset of said reconcile set of tokens, said reconcile conducted via said communication links, thereby splitting the reconcile between directors.

8. The director of claim 7, wherein said first predetermined criteria is based on the volume identifier of said associated volume.

9. The director of claim 7, wherein said director control reconciles the data of said volumes associated with said tokens of said subset of said reconcile set of tokens, in a sequence based on a second predetermined criteria.

10. The director of claim 9, wherein said second predetermined criteria is based on the volume identifier of said associated volume.

11. The director of claim 9, wherein said director control, when reconciling the data of volumes of a said subset of said reconcile set of tokens, additionally senses that a token is being re-read and the data of said volume associated with said re-read token has been reconciled, and ceases reconciling said data of said volumes associated with said tokens of said subset.

12. The director of claim 11, wherein said director, in response to ceasing reconciling said data of said volumes associated with said tokens of said subset, reconciles the data of volumes of said reconcile set of tokens.

13. A method for synchronization reconciling data to be maintained in redundant data storage libraries, each said data storage library having tokens, each said token describing at least one version-related characteristic of an associated volume of data stored by said data storage library, for a system having a plurality of directors, each capable of communicating with said redundant data storage libraries, comprising the steps of:
establishing a reconcile set of said tokens comprising tokens of said redundant data storage libraries describing dissimilar version-related characteristics of a same associated volume;
establishing a plurality of subsets of said reconcile set of tokens based on a first predetermined criteria; and
allocating a said subset of said reconcile set of tokens to at least one of said plurality of directors to reconcile the data of volumes of said allocated subset of said reconcile set of tokens, thereby splitting the reconcile between said directors.

14. The method of claim 13, wherein said first predetermined criteria is based on the volume identifier of said associated volume.

15. The method of claim 13, additionally comprising the step of at least one of said directors reconciling the data of said volumes associated with said tokens of a said subset of said reconcile set of tokens, in a sequence based on a second predetermined criteria.

16. The method of claim 15, wherein said second predetermined criteria is based on the volume identifier of said associated volume.

17. The method of claim 15, additionally comprising the step of, when reconciling the data of volumes of a said subset of said reconcile set of tokens, sensing that a token is being re-read and the data of said volume associated with said re-read token has been reconciled, and ceasing reconciling said data of said volumes associated with said tokens of said subset.

18. The method of claim 17, additionally comprising the step of, in response to ceasing reconciling said data of said volumes associated with said tokens of said subset, reconciling the data of volumes of said reconcile set of tokens.

19. A computer program product usable with at least one programmable computer processor having computer readable code embodied therein, said at least one programmable computer processor for operating a director for synchronization reconciling data to be maintained in redundant data storage libraries, each said data storage library having tokens, each said token describing at least one version-related characteristic of an associated volume of data stored by said data storage library, comprising:
computer readable program code causing said at least one programmable computer processor to establish a reconcile set of said tokens comprising tokens of said redundant data storage libraries describing dissimliar version-related characteristics of a same associated volume;
computer readable program code causing said at least one programmable computer processor to establish a plurality of subsets of said reconcile set of tokens based on a first predetermined criteria; and
computer readable program code causing said at least one programmable computer processor to allocate a said subset of said reconcile set of tokens to at least said director to reconcile the data of volumes of said allocated subset of said reconcile set of tokens, thereby splitting the reconcile between said directors.

20. The computer program product of claim 19, wherein said first predetermined criteria is based on the volume identifier of said associated volume.

21. The computer program product of claim 19, additionally comprising computer readable program code causing said at least one programmable computer processor to reconcile the data of said volumes associated with said tokens of said subset of said reconcile set of tokens, in a sequence based on a second predetermined criteria.

22. The computer program product of claim 21, wherein said second predetermined criteria is based on the volume identifier of said associated volume.

23. The computer program product of claim 21, additionally comprising computer readable program code causing said at least one programmable computer processor to, when reconciling the data of volumes of a said subset of said reconcile set of tokens, additionally sense that a token is being re-read and the data of said volume associated with said re-read token has been reconciled, and cease reconciling said data of said volumes associated with said tokens of said subset.

24. The computer program product of claim 23, additionally comprising computer readable program code causing said at least one programmable computer processor to, in response to ceasing reconciling said data of said volumes associated with said tokens of said subset, reconcile the data of volumes of said reconcile set of tokens.

25. A data storage library system for synchronization reconciling data, comprising:
redundant data storage libraries, each said data storage library having tokens, each said token describing at least one version-related characteristic of an associated volume of data stored by said data storage library; and
a plurality of directors, each capable of communicating with said redundant data storage libraries;
at least one of said plurality of directors establishing a reconcile set of said tokens comprising tokens of said redundant data storage libraries describing dissimilar version-related characteristics of a same associated volume;
at least one of said plurality of directors establishing a plurality of subsets of said reconcile set of tokens based on a first predetermined criteria; and
said plurality of directors reconciling the data of volumes of allotted said subsets of said reconcile set of tokens, thereby splitting the reconcile between said directors.

26. The data storage library system of claim 25, wherein said first predetermined criteria is based on the volume identifier of said associated volume.

27. The data storage library system of claim 25, wherein at least one of said plurality of directors reconciling the data of volumes of a said allotted subset of said reconcile set of tokens, reconciles the data of said volumes associated with said tokens in a sequence based on a second predetermined criteria.

28. The data storage library system of claim 27, wherein said second predetermined criteria is based on the volume identifier of said associated volume.

29. The data storage library system of claim 27, wherein at least one of said plurality of directors reconciling the data of volumes of a said allotted subset of said reconcile set of tokens, additionally senses that a token is being re-read and the data of said volume associated with said re-read token has been reconciled, and ceases reconciling said data of said volumes associated with said tokens of said subset.

30. The data storage library system of claim 29, wherein said at least one of said plurality of directors ceasing reconciling said data of said volumes associated with said tokens of said subset, reconciles the data of volumes of said reconcile set of tokens.
